(19) United States
(12) Patent Application Publication
(10) Pub. No.: US 2023/0309625 A1
(43) Pub. Date: Oct. 5, 2023

(54) ARTICLE FOR USE IN AN AEROSOL PROVISION SYSTEM

(71) Applicant: Nicoventures Trading Limited, LONDON (GB)

(72) Inventor: Gary FALLON, London (GB)

(21) Appl. No.: 18/040,078

(22) PCT Filed: Aug. 2, 2021
(86) PCT No.: PCT/GB2021/051988

§ 371 Date: Jan. 31, 2023

(30) Foreign Application Priority Data
Jul. 31, 2020 (GB) 2011955.8

(51) Int. Cl. A24F 40/485; A24F 40/465; A24D 1/20

(52) U.S. Cl. CPC A24F 40/485; A24D 1/20; A24F 40/465

(57) ABSTRACT

A non-combustible aerosol provision device can include a receptacle that defines a rod shaped consumable receiving space; and a vaporizer for generating an aerosol from an aerosol precursor material; wherein the vaporizer communicates with the rod shaped consumable receiving space so that, in use, aerosol may pass from the vaporizer and into a rod shaped consumable received within the rod shaped consumable receiving space.

### PRIORITY CLAIM

The present application is a National Phase entry of PCT Application No. PCT/GB2021/051988, filed Aug. 02, 2021, which claims priority from GB Application No. 2011955.8, filed Jul. 31, 2020, each of which hereby fully incorporated herein by reference.

### TECHNICAL FIELD

The present disclosure relates to an article for use in a non-combustible aerosol provision system and a non-combustible aerosol provision system including an article.

### BACKGROUND

Certain tobacco industry products produce an aerosol during use, which is inhaled by a user. For example, tobacco heating devices heat an aerosol generating substrate such as tobacco to form an aerosol by heating, but not burning, the substrate.

### SUMMARY

In some embodiments described herein, in a first aspect there is provided a non-combustible aerosol provision device comprising: a receptacle that defines a rod shaped consumable receiving space; and a vaporizer for generating an aerosol from an aerosol precursor material; wherein the vaporizer communicates with the rod shaped consumable receiving space so that, in use, aerosol may pass from the vaporizer and into a rod shaped consumable received within the rod shaped consumable receiving space.

In some embodiments described herein, in a second aspect there is provided a non-combustible aerosol provision system comprising: a non-combustible aerosol provision device according to any of claims 1 to 11; and a rod shaped consumable for insertion into the heater of the non-combustible aerosol provision device.

In some embodiments described herein, in a third aspect there is provided a consumable for use with a non-combustible aerosol provision device comprising: a section of aerosol generating material; a section of filter material forming a mouth end of the consumable; and a plug, that extends across a distal end of the aerosol generating material, opposite the mouth end; wherein the plug comprises a pilot hole that extends at least partially through the plug.

In some embodiments described herein, in a second aspect there is provided a method of making a consumable for use with a non-combustible aerosol provision device, the method comprising: forming a section of aerosol generating material; forming a section of filter material; forming a plug comprising a pilot hole; combining the section of aerosol generating material with the section of filter material, said section of filter material forming a mouth end of the consumable; and attaching the plug to a distal end of the section of aerosol generating material, opposite the mouth end.

### BRIEF DESCRIPTION OF THE DRAWINGS

Embodiments of the disclosure will now be described, by way of example only, with reference to the accompanying drawings, in which:

FIG. 1 schematically illustrates an device according to embodiments of the disclosure.

FIG. 2 schematically illustrates a system according to embodiments of the disclosure.

FIG. 3 schematically illustrates an device according to embodiments of the disclosure.

FIG. 4 schematically illustrates a consumable according to embodiments of the disclosure.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system comprises an electronic cigarette, also known as a vaping device or electronic nicotine delivery system (END), although it is noted that the presence of nicotine in the aerosol-generating material is not a requirement.

In some embodiments, the non-combustible aerosol provision system comprises an aerosol-generating material heating system, also known as a heat-not-burn system. An example of such a system is a tobacco heating system.

In some embodiments, the non-combustible aerosol provision system comprises a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt%, 60 wt% or 70 wt% of amorphous solid, to about 90 wt%, 95 wt% or 100 wt% of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

In the figures described herein, like reference numerals are used to illustrate equivalent features, articles or components.

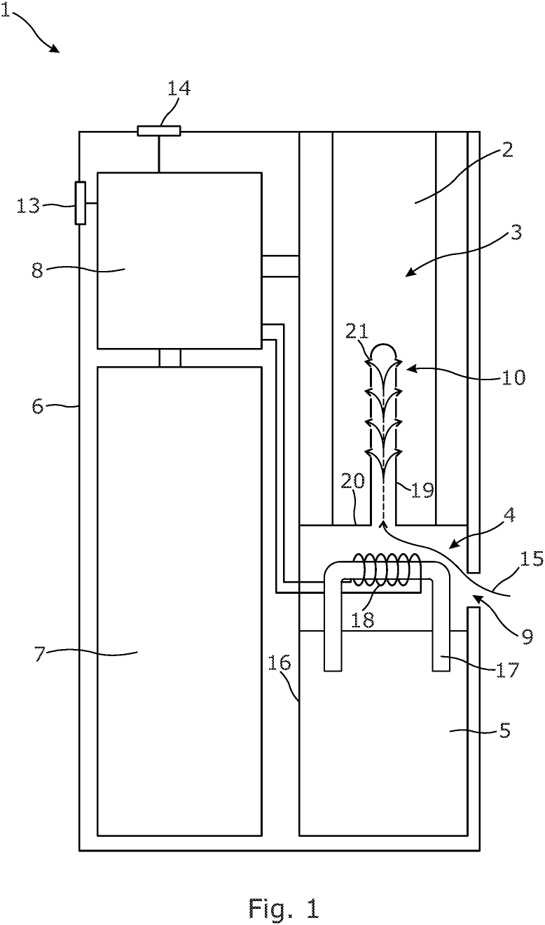

A non-combustible aerosol provision device 1 (herein referred to simply as the ‘device 1’) according to embodiments of the disclosure is shown schematically in FIG. 1. The device 1 comprises a receptacle 2 that defines a rod shaped consumable receiving space 3 (herein referred to simply as ‘receiving space 3’); and an aerosol generator 4 for generating an aerosol from an aerosol-former material 5 such as an e liquid. In the illustrated embodiment, the aerosol generator is a vaporizer 4.

The vaporizer 4 is in fluid communication with the receiving space 3 so that, in use, aerosol may pass from the vaporizer 4 and into a rod shaped consumable (herein referred to simply as ‘the consumable’) received in the receiving space 3.

The device further comprises a power source 7 and a control unit 8 which are configured to power and control the vaporizer 4, respectively. The power source 7 may be, for example, a battery 7, such as a rechargeable battery or a non-rechargeable battery. Examples of suitable batteries include, for example, a lithium battery (such as a lithium-ion battery), a nickel battery (such as a nickel-cadmium battery), and an alkaline battery.

The various components of the device, including the vaporizer 4, receptacle 2, battery 7 and control unit 8 are retained within a housing 6.

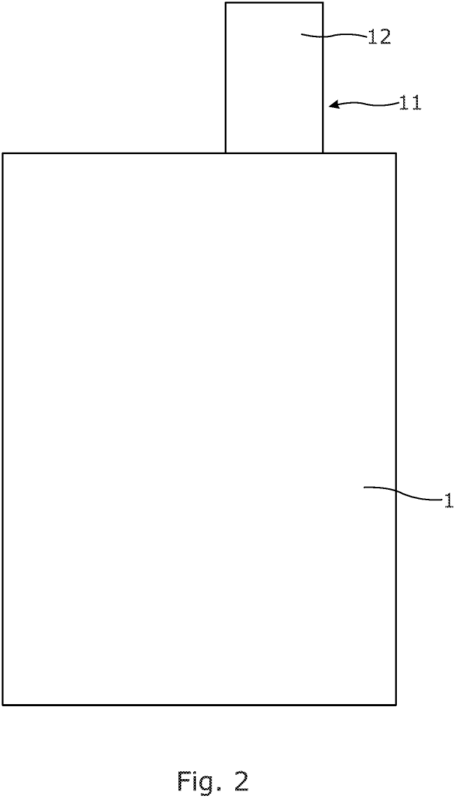

The device 1 is of the approximate size and shape to allow a user to hold the device 1 in a single hand. In use, a consumable 11 is inserted into the receiving space 3, as shown in FIG. 2. A mouth end 12 of the consumable protrudes from the device. To inhale the aerosol generated by the vaporizer, a user places the mouth end 12 of the consumable 11 between their lips and draws on the consumable 11, in the manner of a conventional cigarette.

The device further comprises an inlet 9 and an outlet 10. An air passageway is defined between the inlet and outlet 9, 10 which passes through the vaporizer 4. The outlet opens into the receiving space 3 to allow aerosol generated by the vaporizer 4 to pass through a consumable 11 received within the receiving space 3.

When a user draws on the consumable 11, a pressure differential is generated between the air inlet 9 and the air outlet 10. The pressure differential induces a flow of air (indicated by arrow 15) from the inlet 9, through the vaporizer 4 and out of the outlet 10. Aerosol from the vaporizer 4 is picked up and entrained in the flow of air 15 and - having passed through the outlet 10 - passes through the consumable 11 for inhalation by the user.

In some embodiments, the device 1 comprises a first activation button 13 to allow a user to turn the device 1 on or off; and a second activation button 14 to activate the vaporizer 4. To use the device 1, a user draws on the mouth end 12 of the consumable 11 while simultaneously pressing the second activation button 14 to cause the vaporizer 4 to generate an aerosol.

In some embodiments, the inlet 10 may comprise a pressure sensor (not shown) which acts as a ‘puff sensor’. The puff sensor is configured to detect a drop in pressure at the air inlet 9 which indicates that a user is drawing on a consumable 11 located within the receiving space 3. The device 1 is thereby configured to activate the vaporizer 4 in response to a drop in pressure detected at the air inlet 9.

The control unit 8 is configured to direct electrical energy from the battery 7 to activate the vaporizer 4 in response to an input signal.

In one embodiment, the input signal is generated when the second activation button 14 is pressed by the user. In another embodiment, the input signal is generated when a pressure drop is detected at the inlet 9 by a pressure sensor.

In some embodiments, and as illustrated in FIG. 1, the vaporizer comprises an aerosol-former tank 16, a wick 17 and an electrical resistance heater 18. In use, the aerosol-former material 5 is drawn into the wick 17 by capillary action and thereby vaporized by heat delivered by the electrical resistance heater 18.

The electrical resistance heater 18 comprises a conductive wire that generates heat due to electrical resistance to a current induced in the wire. The wire is wound around the wick 17 in a spiral and is electrically connected to the control unit 8.

In response to the input signal, the electrical potential of the battery 7 induces a current in the wire of the electrical resistance heater 18 and vaporizes aerosol-former material supported by the wick 17. Additional aerosol-former material 5 is drawn from the aerosol-former tank 16 to replenish aerosol-former material 5 as and when it is vaporized.

The aerosol-former tank 16 may be refillable to allow aerosol-former material to be topped up as the tank 16 is depleted.

In some embodiments, the vaporizer 4 may consist of a disposable unit that can be removed and replaced when the aerosol-former tank 16 is empty. The disposable unit necessitates an electrical interface to allow the disposable unit to communicate with the control unit 8. The electrical interface may comprise electrical contacts that are connected when the disposal unit is inserted into the device 1 in the appropriate orientation. The disposable unit may be held in the device 1 by any suitable connection mechanism, such a releasable clip, bayonet connection or the like.

In some embodiments, and as illustrated in FIG. 1, the device further comprises an aerosol distribution column 19. The aerosol distribution column 19 upstands from a base 20 of the receptacle 2 and into the rod shaped consumable receiving space 3. In use, a rod shaped consumable may be placed over the aerosol distribution column 19 so that the aerosol distribution column 19 extends within the rod shaped consumable.

The aerosol distribution column 19 comprises an internal bore (not shown) which communicates at least one aperture 21 in the aerosol distribution column 19 with the vaporizer 4. The at least one aperture 21 provides the outlet 10 for aerosol from the vaporizer to pass into a consumable 11 received in the consumable receiving space 3.

In some embodiments, the outlet 10 comprises a plurality of apertures 21 spaced along the aerosol distribution column 19. The apertures 21 may be arranged in rows in an axial direction of the aerosol distribution column 19. Said rows of apertures 21 may be spaced around the circumference of the aerosol distribution column 19 to evenly distribute aerosol within a consumable 11 received in the consumable receiving space 3.

A lowermost aperture 21 of each row of apertures 21 may be spaced from the base 20 of the receptacle 2 to reduce the accumulation of condensate within the receptacle 2, as will be explained further below. Each lowermost aperture 21 may be positioned between 10% and 50% of the way along the length of the aerosol distribution column 19, starting from the base 20 of the receptacle. In one embodiment, each lowermost aperture 21 is positioned between 30% of the way along the length of the aerosol distribution column 19, starting from the base 20 of the receptacle

The consumable further comprises a distal end, opposite the mouth end 12. The distal end is therefore most proximate the base 20 of the receptacle when received in the consumable receiving space 3. It is desirable to introduce aerosol into the consumable 11 at a predetermined distance from the distal end of the consumable 11; in some embodiments, this is achieved by the abovementioned spacing of each lowermost aperture 21 from the base 20 of the receptacle 2.

During use of the device 1, a proportion of the aerosol will inevitably condense during transit between the vaporizer 4 and the user’s mouth. Condensate formed in the consumable 11 has a tendency to leak from the distal end of the consumable 11 and accumulate in the receptacle 2. By introducing condensate into the consumable 11 at a predetermined distance from the distal end of the consumable 11, condensing condensate is better absorbed by the consumable 11 and less likely to leak from its distal end.

In some embodiments, the aerosol distribution column 19 is heated. By heating the aerosol distribution column 19, the total heat content (enthalpy) of the aerosol is increased by heat transferred from the aerosol distribution column 19 to the aerosol. Increasing the enthalpy of the aerosol reduces its tendency to precipitate. Therefore, by specifying a spacing of each lowermost aperture 21 from the base 20 of the receptacle 2, the enthalpy of the aerosol can be increased prior to the aerosol passing into a consumable 11 received in the consumable receiving space 3 and, therefore, the tendency of the aerosol to condense in the consumable 11 is reduced.

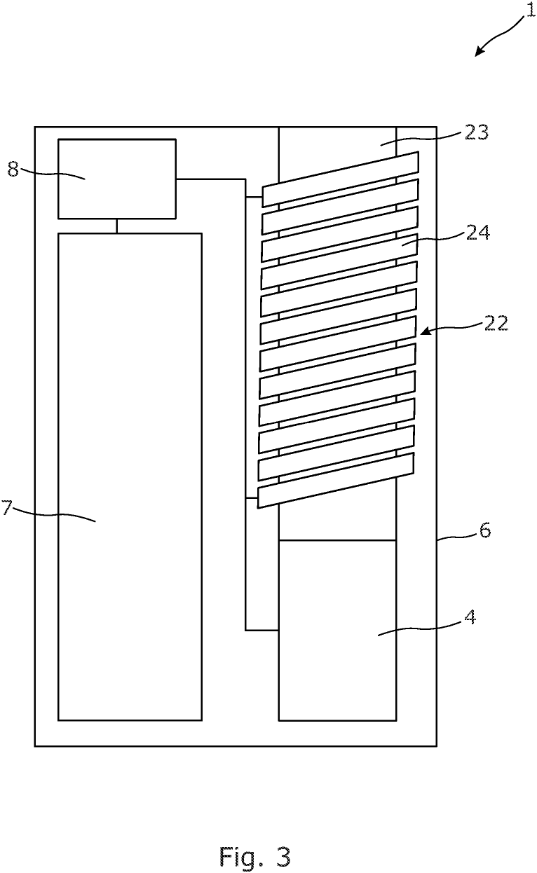

In some embodiments, and as illustrated by FIG. 3, the device 1 further comprises a heater 22 configured to heat the consumable receiving space 3. The heater 22 is electrically coupled to the battery 7 under the control of the control unit 8. The control unit 8 is configured to direct electrical energy from the battery 7 to activate the heater 22 in response to an input signal.

In one embodiment, the input signal is generated when the second activation button 14 is pressed by the user. In another embodiment, the input signal is generated when a pressure drop is detected at the inlet 9 by a pressure sensor.

In some embodiments, the heater 22 is an inductive heating assembly 22 and comprises various components to heat the consumable receiving space via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

In some embodiments, and as illustrated by FIG. 3, the inductive heating assembly comprises a susceptor 23 and an inductor coil 24. The inductor coil 24 is made from an electrically conducting material. In the illustrated embodiment, the inductor coil 24 is made from Litz wire/cable which is wound in a helical fashion about the susceptor 23. Litz wire comprises a plurality of individual wires which are individually insulated and are twisted together to form a single wire. Litz wires are designed to reduce the skin effect losses in a conductor. In the illustrated embodiment, the inductor coil 24 is made from copper Litz wire which has a rectangular cross section. In other examples the Litz wire can have other shape cross sections, such as circular. The inductor coil 24 is configured to generate a varying magnetic field for heating the susceptor 23.

The susceptor 23 of the illustrated embodiment is cylindrical and hollow and defines the receptacle 3 within which the consumable 11 is received. For example, the consumable 11 can be inserted into the susceptor 23. In the illustrated embodiment, the susceptor 23 is tubular, with a circular cross section.

The susceptor 23 may be made from one or more materials. In some examples the susceptor 23 comprises carbon steel having a coating of Nickel or Cobalt.

In some embodiments, the device 1 further comprises an insulating member (not shown). The insulating member may be generally tubular and disposed between the susceptor 23 and the inductor coil 24. The insulating member may be constructed from any insulating material, such as plastic for example. In this particular example, the insulating member is constructed from polyether ether ketone (PEEK). The insulating member may help insulate the various components of the device from the heat generated in the susceptor 23.

In some embodiments, the outer surface of the susceptor 23 is spaced apart from the inner surface of the inductor coil 24 by a distance, measured in a direction perpendicular to a longitudinal axis of the susceptor 23. In one particular example, the distance is about 3 mm to 4 mm, about 3-3.5 mm, or about 3.25 mm.

In some embodiments, the outer surface of the insulating member is spaced apart from the inner surface of the inductor coil 24 by a distance, measured in a direction perpendicular to a longitudinal axis of the susceptor 23. In one particular example, the distance is about 0.05 mm. In another example, the distance is substantially 0 mm, such that the inductor coil 24 abuts and touches the insulating member.

In some embodiments, the susceptor 23 has a wall thickness of about 0.025 mm to 1 mm, or about 0.05 mm.

In some embodiments, the susceptor 23 has a length of about 40 mm to 60 mm, about 40 mm to 45 mm, or about 44.5 mm.

In some embodiments, the insulating member has a wall thickness of about 0.25 mm to 2 mm, 0.25 mm to 1 mm, or about 0.5 mm.

In some embodiments, the aerosol distribution column 19 is configured to be inductively heated by the inductive heating assembly 22. In such embodiments, the aerosol distribution column 19 comprises an electrically conducting material which serves as an additional susceptor. The electrically conducting material may be a ferromagnetic material such as iron, nickel or cobalt.

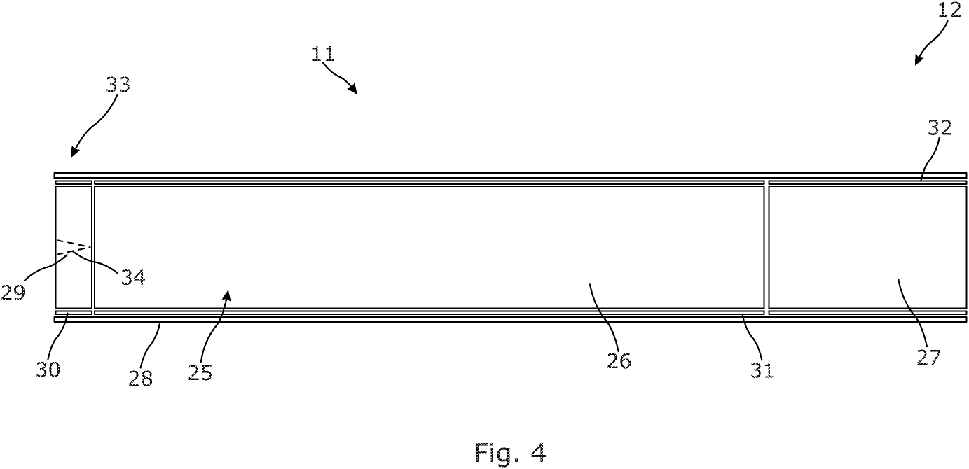

FIG. 4 shows the consumable 11 according to embodiments of the disclosure. The consumable 11 comprises a rod of aerosol generating material 25, which in some embodiments comprises a tobacco material 26.

The tobacco material 26 may comprise conventionally cured tobacco that has been cut or shredded in the normal way. Such tobacco is similar to the tobacco found in cigarettes.

In another embodiment, the tobacco material may 26 be reconstituted to make a tobacco paper which is then shredded or cut into strips. The tobacco paper may be further impregnated with an aerosol former material such as glycerine, glycerol or propylene glycol. Therefore, heat from the aerosol vaporizes the aerosol former material as it passes through the rod of aerosol generating material 25 during inhalation by a user. Advantageously, the aerosol former material will be flavored by the tobacco paper to provide a tobacco flavor to the aerosol.

In some embodiments, the tobacco paper comprises longitudinal strips of tobacco paper, each longitudinal strip being arranged substantially parallel to a longitudinal axis of the article. Therefore, the resistance to draw of the rod of aerosol generating material 25 is reduced.

In another embodiment, the tobacco material 26 is reconstituted to make beads of tobacco. The beads of tobacco may have a mean diameter of 0.5 mm to 3 mm. It shall be appreciated that for a given volume occupied by the beads of tobacco, the smaller the mean diameter, the larger the collective surface area presented by the beads of tobacco. Advantageously, the flavor imparted to the aerosol is proportional to the surface area presented by the beads of tobacco.

In some embodiments the rod of aerosol generating material 25 comprises a first wrapping material 31. The first wrapping material may be electrically conducting, such as aluminum foil, metalized paper or a braided ferrous material. Therefore the first wrapping material may serve as an additional susceptor to the inductive heating assembly 22. The first wrapping material circumscribes the rod of aerosol generating material 25 so that edges of the first wrapping material 31 overlap. Overlapping edges of the first wrapping material are adhered along a lap seam.

The rod of aerosol generating material 25 is attached to a filter section 27 by a tipping material 28. The tipping material 28 circumscribes the rod of aerosol generating material 25 and the filter section 27 so that edges of the tipping material 28 overlap. Overlapping edges of the tipping material 28 are adhered along a lap seam.

The filter section 27 comprises a cylindrical body of filter material wrapped in a plug wrap 32. The plug wrap 32 is disposed between the filter material and the tipping material 28.

In some embodiments, the distal end 33 of the consumable 11 further comprises a plug 29. The plug 29 comprises a disc of material that extends across the end of the rod of aerosol generating material and is attached thereto by the tipping material 28. In some embodiments, the plug 29 further comprises a plug wrapper 30 disposed between the plug and the tipping material 28.

In some embodiments, the plug 29 may be impermeable to prevent condensate from leaking out of the distal end of the consumable 11, during use.

In some embodiments, the plug comprises a pilot hole 34 to configured to receive the aerosol distribution column when the rod shaped consumable is inserted into the aerosol provision device. The pilot hole 34 allows the aerosol distribution column to pass through the plug without having to pierce the plug 29. In some embodiments the pilot hole 29 is tapered, the taper being widest at the distal end. In some embodiments, the pilot hole does not extend all the way through the plug 29.

In the present example, the consumable 11 has an outer circumference of about 21 mm (i.e. the consumable is in the demi-slim format). In some examples, the consumable 11 has a rod of aerosol generating material 25 with a circumference greater than 19 mm. Where the consumable 11 is heated, heat transfers through the rod of aerosol generating material 25 to volatile components of the rod of aerosol generating material 25, and circumferences greater than 19 mm have been found to be particularly effective at producing an aerosol in this way. Since the consumable 11 may be heated to release an aerosol, improved heating efficiency can be achieved using consumables 11 having circumferences of less than about 23 mm. To achieve improved aerosol via heating, while maintaining a suitable product length, circumferences of greater than 19 mm and less than 23 mm can be advantageous. In some examples, the circumference can be between 20 mm and 22 mm, which has been found to provide a good balance between providing effective aerosol delivery while allowing for efficient heating.

The outer circumference of the filter section 27 is substantially the same as the outer circumference of the rod of aerosol generating material 25 and the plug 29, such that there is a smooth transition between these components. In the present example, the outer circumference of the filter section 27 is about 20.8 mm.

The tipping material 28 can have a basis weight which is higher than the basis weight of the other wrapping materials 30, 31, 32 used in the consumable 11, for instance a basis weight of 40 gsm to 80 gsm, such as between 50 gsm and 70 gsm, and in the present example 58 gsm. These ranges of basis weights have been found to result in tipping materials having acceptable tensile strength while being flexible enough to wrap around the consumable 11 and adhere to itself along overlapping longitudinal edges.

In some examples, the tipping material 28 and/or the first wrapping material 31 and/or plug wrapper 30 comprises citrate, such as sodium citrate or potassium citrate. In such examples, the materials 28, 31, 30 may have a citrate content of 2% by weight or less, or 1% by weight or less. Reducing the citrate content is thought to assist with reducing the charring effect which may occur during use.

In some embodiments, the respective wrapping materials 30, 31, 32 of the plug 29, rod of aerosol generating material 25 and filter section 27 have a basis weight of less than 50 gsm, such as between about 20 gsm and 40 gsm. In some examples, said wrapping materials 30, 31, 32 have a thickness of between 30 µm and 60 µm, such as between 35 µm and 45 µm. In some examples, said wrapping materials 30, 31, 32 are a non-porous, for instance having a permeability of less than 100 Coresta units, for instance less than 50 Coresta units. However, in other embodiments, said wrapping materials 30, 31, 32 can be porous, for instance having a permeability of greater than 200 Coresta Units. In some examples, the length of the filter section 27 is less than about 20 mm. In the present example, the length of the filter section 27 is 16 mm.

In some embodiments, the filter section 27 comprises a body formed from filamentary tow. In the present example, the tow used in the body has a denier per filament (d.p.f.) of 8.4 and a total denier of 21,000. Alternatively, the tow can, for instance, have a denier per filament (d.p.f.) of 9.5 and a total denier of 12,000. In the present example, the tow comprises plasticized cellulose acetate tow. The plasticizer used in the tow comprises about 7% by weight of the tow. In the present example, the plasticizer is triacetin. In other examples, different materials can be used to form the body. For instance, rather than tow, the body of the filter section 27 can be formed from paper, for instance in a similar way to paper filters known for use in cigarettes. Alternatively, the body can be formed from tows other than cellulose acetate, for instance polylactic acid (PLA), other materials described herein for filamentary tow or similar materials. The tow can be formed from cellulose acetate. The tow, whether formed from cellulose acetate or other materials, can have a d.p.f. of at least 5, such as at least 6, and for example at least 7. These values of denier per filament provide a tow which has relatively coarse, thick fibers with a lower surface area which result in a lower pressure drop across the filter section 6 than tows having lower d.p.f. values. In some examples, to achieve a sufficiently uniform body, the tow has a denier per filament of no more than 12 d.p.f., such as no more than 11 d.p.f. and for example no more than 10 d.p.f.

The total denier of the tow forming the body of the filter section 27 can be at most 30,000, such as at most 28,000 and for example at most 25,000. These values of total denier provide a tow which takes up a reduced proportion of the cross sectional area of the filter section 27 which results in a lower pressure drop across the filter section 27 than tows having higher total denier values. For appropriate firmness of the filter section 27, the tow can have a total denier of at least 8,000 and for example at least 10,000. In some examples, the denier per filament is between 5 and 12 while the total denier is between 10,000 and 25,000. For example, the denier per filament is between 6 and 10 while the total denier is between 11,000 and 22,000. In some examples the cross-sectional shape of the filaments of tow are ‘Y’ shaped, although in other embodiments other shapes such as ‘X’ shaped filaments can be used, with the same d.p.f. and total denier values as provided herein.

The cross section of the filaments of tow may have an isoperimetric ratio L2/A of 25 or less, 20 or less, or 15 or less, where L is the length of the perimeter of the cross section and A is the area of the cross section. Such filaments of tow have a relatively low surface area for a given value of denier per filament, which improves delivery of aerosol to the consumer. In some examples, the body may comprise an adsorbent material (e.g. charcoal) dispersed within the tow.

In some examples, the body of the filter section 27 may comprise a capsule. The capsule can comprise a breakable capsule, for instance a capsule which has a solid, frangible shell surrounding a liquid payload. In some examples, a single capsule is used. The capsule is entirely embedded within the body of the filter section 27. In other words, the capsule is completely surrounded by the material forming the body. In other examples, a plurality of breakable capsules may be disposed within the body of the filter section 27, for instance 2, 3 or more breakable capsules. The length of the body of the filter section 27 can be increased to accommodate the number of capsules required. In examples where a plurality of capsules is used, the individual capsules may be the same as each other, or may differ from one another in terms of size and/or capsule payload. In other examples, multiple bodies of material may be provided, with each body containing one or more capsules.

The capsule has a core-shell structure. In other words, the capsule comprises a shell encapsulating a liquid agent, for instance a flavorant or other agent, which can be any one of the flavorants or aerosol modifying agents described herein. The shell of the capsule can be ruptured by a user to release the flavorant or other agent into the body of the filter section 27. The filter section plug wrap 32 can comprise a barrier coating to make the plug wrap 32 substantially impermeable to the liquid payload of the capsule. Alternatively or in addition, the plug wrap 32 can comprise a barrier coating to make the plug wrap 32 substantially impermeable to the liquid payload of the capsule.

In some examples, the capsule is spherical and has a diameter of about 3 mm. In other examples, other shapes and sizes of capsule can be used. The total weight of the capsule may be in the range about 10 mg to about 50 mg.

It is known to generate, for a given tow specification (such as 8.4Y21000), a tow capability curve which represents the pressure drop through a length of rod formed using the tow, for each of a range of tow weights. Parameters such as the rod length and circumference, wrapper thickness and tow plasticizer level are specified, and these are combined with the tow specification to generate the tow capability curve, which gives an indication of the pressure drop which would be provided by different tow weights between the minimum and maximum weights achievable using standard filter rod forming machinery. Such tow capability curves can be calculated, for instance, using software available from tow suppliers. It has been found that it is particularly advantageous to use a body for a filter section 27 which includes filamentary tow having a weight per mm of length of the body which is between about 10% and about 30% of the range between the minimum and maximum weights of a tow capability curve generated for the filamentary tow. This can provide an acceptable balance between providing enough tow weight to avoid shrinkage after the body has been formed, providing an acceptable pressure drop, while also assisting with capsule placement within the tow, for capsules of the sizes described herein.

In some embodiments, the filter section 27 may further comprise a hollow tubular element that extends from the mouth end 12 and is attached to the filter section by the plug wrap 32. The hollow tubular element may advantageously have a length of greater than about 10 mm, for instance between about 10 mm and about 30 mm or between about 12 mm and about 25 mm. It has been found that a consumer’s lips are likely to extend in some cases to about 12 mm from the mouth end 12 of the consumable 11 when drawing aerosol through the consumable 11, and therefore a hollow tubular element having a length of at least 10 mm or at least 12 mm means that most of the consumer’s lips surround this element.

In some embodiments, a method of making the consumable 11 comprises: forming a section of aerosol generating material 25; forming a section of filter material 27; forming a plug 29 comprising a pilot hole 34; combining the section of aerosol generating material 25 with the section of filter material 27, said section of filter material 27 forming the mouth end 12 of the consumable 11; and attaching the plug 29 to a distal end 33 of the section of aerosol generating material 25, opposite the mouth end 12.

1. A non-combustible aerosol provision device comprising:
a receptacle that defines a rod shaped consumable receiving space; and
a vaporizer for generating an aerosol from an aerosol precursor material, wherein the vaporizer communicates with the rod shaped consumable receiving space so that, in use, aerosol may pass from the vaporizer and into a rod shaped consumable received within the rod shaped consumable receiving space.

2. The non-combustible aerosol provision device according to claim 1, further comprising an aerosol distribution column that upstands from a base of the receptacle and into the rod shaped consumable receiving space, so that, in use, the rod shaped consumable may be placed over the aerosol distribution column so that the aerosol distribution column extends within the rod shaped consumable, and wherein the aerosol distribution column is configured to introduce aerosol directly into the rod shaped consumable received within the rod shaped consumable receiving space.

3. The non-combustible aerosol provision device according to claim 2, wherein an internal bore of the aerosol distribution column communicates the vaporizer with an aperture in the aerosol distribution column, so that aerosol may pass from the vaporizer through the aperture and into the rod shaped consumable received within the rod shaped consumable receiving space.

4. The non-combustible aerosol provision device according to claim 3, wherein the internal bore communicates with a plurality of apertures spaced along a length of the aerosol distribution column.

5. The non-combustible aerosol provision device according to claim 4, wherein a lowermost aperture of the plurality of apertures is positioned between 10% and 50% of the way along the length of the aerosol distribution column, measured from the base of the receptacle.

6. The non-combustible aerosol provision device according to claim 1, further comprising a heater configured to heat the rod shaped consumable receiving space.

7. The non-combustible aerosol provision device according to claim 6, wherein the heater comprises an inductor coil that extends around the receptacle.

8. The non-combustible aerosol provision device according to claim 7, wherein the receptacle comprises a cylindrical wall, and wherein the cylindrical wall is configured to be inductively heated by the inductor coil.

9. The non-combustible aerosol provision device according to claim 8, wherein the aerosol distribution column is configured to be inductively heated by the inductor coil.

10. A non-combustible aerosol provision system comprising:
a non-combustible aerosol provision device according to claim 1; and
a rod shaped consumable for insertion into the heater of the non-combustible aerosol provision device.

11. The non-combustible aerosol provision system according to claim 10, wherein the rod shaped consumable comprises an aerosol generating material.

12. The non-combustible aerosol provision system according to claim 11, wherein the aerosol generating material comprises tobacco material.

13. The non-combustible aerosol provision system according to claim 12, wherein the tobacco material comprises tobacco granules.

14. The non-combustible aerosol provision system according to claim 13, wherein the tobacco granules comprise cut tobacco.

15. The non-combustible aerosol provision system according to claim 13, wherein the tobacco granules comprise beads of tobacco.

16. The non-combustible aerosol provision system according to claim 12, wherein the tobacco material comprises a tobacco paper.

17. The non-combustible aerosol provision system according to claim 16, wherein the tobacco paper comprises longitudinal strips of tobacco paper, each longitudinal strip being arranged substantially parallel to a longitudinal axis of the rod shaped consumable.

18. The non-combustible aerosol provision system according to claim 11, wherein the aerosol generating material further comprises an aerosol-former material.

19. The non-combustible aerosol provision system according to claim 18, wherein the aerosol former material comprises at least one of: glycerine, glycerol or propylene glycol.

20. The non-combustible aerosol provision A system according to claim 11, wherein the rod shaped consumable further comprises a filter section forming a mouth end.

21. The non-combustible aerosol provision system according to claim 20, wherein the aerosol generating material and the filter section are combined by at least one wrapping material.

22. The non-combustible aerosol provision system according to claim 21, wherein the at least one wrapping material comprises a susceptor.

23. The non-combustible aerosol provision system according to claim 22, wherein the susceptor comprises aluminum foil.

24. The non-combustible aerosol provision system according to claim 22, wherein the susceptor comprises a braided material.

25. The non-combustible aerosol provision system according to claim 24, wherein the braided material comprises a ferrous material.

26. The non-combustible aerosol provision system according to claim 20, wherein the rod consumable further comprises a plug disposed in a distal end of the rod shaped consumable, opposite the mouth end.

27. The non-combustible aerosol provision system according to claim 26, further comprising an aerosol distribution column that upstands from a base of the receptacle and into the rod shaped consumable receiving space, so that, in use, the rod shaped consumable may be placed over the aerosol distribution column so that the aerosol distribution column extends within the rod shaped consumable, wherein the aerosol distribution column is configured to introduce aerosol directly into the rod shaped consumable received within the rod shaped consumable receiving space, and wherein the plug comprises a pilot hole configured to receive the aerosol distribution column when the rod shaped consumable is inserted into the aerosol provision device.

28. A consumable for use with a non-combustible aerosol provision device, the consumable comprising:
a section of aerosol generating material;
a section of filter material forming a mouth end of the consumable; and
a plug that extends across a distal end of the aerosol generating material, opposite the mouth end,
wherein the plug comprises a pilot hole that extends at least partially through the plug.

29. A method of making a consumable for use with a non-combustible aerosol provision device, the method comprising:
forming a section of aerosol generating material;
forming a section of filter material;
forming a plug comprising a pilot hole;
combining the section of aerosol generating material with the section of filter material, the section of filter material forming a mouth end of the consumable; and
attaching the plug to a distal end of the section of aerosol generating material, opposite the mouth end.
